(19) United States
(12) Patent Application Publication
(10) Pub. No.: US 2013/0317895 A1
(43) Pub. Date: Nov. 28, 2013

(54) Wireless Mobile Communication System Rewards Royalty System and Method

(71) Applicants: Chris Turner, Orange, CA (US); Rick Sturdivant, Placentia, CA (US); Joaquin Felipe Brown, Culver City, CA (US)

(72) Inventors: Chris Turner, Orange, CA (US); Rick Sturdivant, Placentia, CA (US); Joaquin Felipe Brown, Culver City, CA (US)

(21) Appl. No.: 13/477,117

(22) Filed: May 22, 2012

(51) Int. Cl. G06Q 30/02; H04W 4/02

(52) U.S. Cl. 705/14.16; 705/14.27

(57) ABSTRACT

A consumer-based purchase and referral rewards loyalty system is disclosed. In the system, mobile communication devices include a location tracking devices. Data tags or other wireless communication devices are enabled to communicate with one or more mobile communication devices and to collect an identification code of each. Custom sales presentation module communicatively couples to the mobile communication devices and the data tags or wireless communication devices. Responsive to a locality of goods or services proximal to or predicted proximal to the location tracking devices, the custom sales presentation module generates a user specific sales presentation, which is sent to one or more mobile communication devices to advertise products or services.

### PRIORITY AND RELATED APPLICATION(S)

This US non-provisional utility patent application is co-pending with, claims priority to, and incorporates by reference in its entirety US non-provisional utility patent application entitled “LOCATION DETERMINATION SYSTEM AND METHOD USING ARRAY ELEMENTS FOR LOCATION TRACKING” Ser. No. 13/349,565, filed on Jan. 13, 2012, incorporates by reference in its entirety US non-provisional utility patent application entitled “SIGNAL RESET CIRCUIT FOR WIRELESS COMMUNICATION SYSTEMS” Ser. No. 13/349,561 filed on Jan. 13, 2012; claims priority to and incorporates by reference in its entirety US non-provisional application entitled “DYNAMIC WIRELESS NETWORKS AND INTERACTIVE WIRELESS INFORMATION COMMUNICATION AND DELIVERY SYSTEMS FOR CALCULATING DISTANCE TO AN OBJECT”, Ser. No. 13/310,761 filed on Dec. 4, 2011, and claims priority to and incorporates by reference in its entirety co-pending U.S. Utility patent application Ser. No. 13/010,437 filed on Jan. 20, 2011.

### BACKGROUND OF THE DISCLOSURE

1. Field of the Disclosure

The invention relates generally to the field of interactive wireless royalty rewards systems, and specifically in one exemplary aspect to royalty and rewards systems employing an interactive wireless information system for advertisements and referrals transactions and software, hardware, and related thereof.

2. Description of Related Technology

Referral systems and advertisement processes, both apparatuses and methodologies, are well known in the art. For instance, sales, marketing, and interactive processing, such as related to consumer transactions and advertisements to attract consumers and encourage purchase behavior.

For instance, multi-level marketers, brick and mortar companies, e.g., Avon, Jiffy Lube, Costco, and consumers alike are provided with a new set of problems including the challenge of filtering information that meet their specific, but ever changing needs. For instance, both are demanding that information is easily available and relevant to their immediate needs or location in order to support purchase decisions and make informed choices. Conventional electronic information storage and display systems, e.g., kiosk interactive screens, home computers having internet access, stand-alone or dedicated computers that are located in a store setting, allow consumers to browse electronically for desired products or services. However, using conventional Internet search engines and methods of browsing, scanning, or searching for products or services, there is a disconnect of how to efficiently locate, track, search and store received information from multi-media sources such as Internet, Television, Radio, or the like that is streamed, downloaded, or browsed, and to make consumers shopping lives easier.

Thus, there is a need for capability to connect digital content to buyers and sellers of products and services to provide improved accessibility to, for instance, consumers', multi-level marketers', and brick & mortar companies' immediate or pending desires or needs. As such, there is still a need for improved information processing processes and apparatuses that permit easy initial, configuring and reconfiguring, i.e., improved accessibility between a physical world of product and service providers and distributors, to improve real-time capability to connect digital content to buyers and sellers of products and services to provide improved accessibility to a consumers or multi-level marketers immediate or pending desires or needs, which may minimize the required labor and/or time from initial information screening to retrieval of relevant content and/or latest promotions and news about products and transactions. Such improved apparatus and methods would ideally minimize labor-intensive tasks of adjustment and/or installation of algorithms and structures.

Furthermore, it would be advantageous for an improved process or system to provide multiple configurations, and thus permit the creation of user-customized consumer and marketer configurations using one or more structures or components and software routines. In addition, the improved process or system should assist marketers and consumers in browsing, searching, and scanning of targeted products and services and thereby potentially reduce a number or magnitude thereof of required efforts by a consumer or marketer, such as a retail store, product distributor, or wholesale retailer.

### SUMMARY

In one aspect, a consumer-based purchase and referral rewards loyalty system is disclosed. In this system, one or more location tracking devices are communicatively coupled to one or more mobile communication devices. One or more data tags have at least one data processing unit enabled to communicatively couple with at least one memory unit to collect an identification code of the one or more location tracking devices. Custom sales presentation module is communicatively coupled to one or more location tracking devices and one or more data tags. Custom sales presentation generates a user specific sales presentation responsive to a locality of goods or services proximal to or predicted to be proximal to a location of at least one of the one or more location tracking devices or other actions by a user or a recommender.

In another aspect, a system includes a wireless mobile application that is stored in non-volatile memory of one or more mobile communication devices. One or more mobile communication device communicatively couples to an internal processor unit. Rewards software program records, stores, communicates, and is executable on internal mobile communication processor. In one variant, wireless mobile application is configured to display user statics on user interface and generate monetary rewards or offers responsive to wireless mobile phone usage based on recorded time of mobile communication device proximal to a location near a Wi-Fi or group(s) of one or more tagged devices.

In another aspect, a method is disclosed for operating a consumer-based rewards loyalty program. The method communicates by at least one processing unit from one or more data tags to one or more mobile communication devices having location tracking device, at least one memory unit, and one or more processing units. In addition, the method generates a user specific sales presentation from a custom sales presentation module. In one aspect, the user specific sales presentation responds to a locality of goods or services proximal to or predicted to be proximal to the one or more location tracking devices and the one or more data tags. In addition, the method may include communicatively coupling the user specific sales presentation to the mobile communication devices.

These and other embodiments, aspects, advantages, and features of the present disclosure will be set forth in part in the description which follows, and in part will become apparent to those skilled in the art by reference to the following description of the disclosure and referenced drawings or by practice of the disclosure. The aspects, advantages, and features of the disclosure are realized and attained by means of the instrumentalities, procedures, and combinations particularly pointed out in the appended claims.

### BRIEF DESCRIPTION OF THE DRAWINGS

FIG. 1 is a block diagram that illustrates a consumer-based purchase and referral rewards loyalty system 100;

FIG. 2 is a block diagram that illustrates a system 200 including wireless mobile application 202 stored in non-volatile memory location 204 of mobile communication device 206; and

FIG. 3 is a flow chart illustrating the consumer-based purchase and referral rewards loyalty system 100 and 200 of FIGS. 1 and 2.

### DETAILED DESCRIPTION

Reference is now made to the drawings wherein like numerals refer to like parts throughout.

### Overview

In one salient aspect, the present application discloses apparatuses and methods for implementing a consumer-based purchase and/or referral rewards loyalty program related to, inter alia, mobile communication devices including location tracking devices. In particular, the present disclosure discloses an apparatus and method configurable to assist a multi-level marketer or consumer in evaluating and processing information and locating information on products and services proximal thereto. Furthermore, the present disclosure further indicates a technique for accurately portraying in real-time, information about products and services of more readily identified, such as locally available or proximal products or services. In addition, for a mobile cell phone, a consumer profile is accessed by the application on products and services transactions as well as mobile cell phone location information are collected as well as empirical data associated with groups of others in a convenient database that may be reviewed and accessed in a convenient manner.

In addition, the apparatus, methods, and systems within advantageously provides a more intuitive method to view information, provide rewards and loyalty points to valued customers, retailers, and recommenders, related to consumer transactions in real-time situations where current methods for Internet searching, review of Internet search results, and human searching through retailers' provided advertisements cannot readily provide such detailed information or availability of transactional information without significant efforts. For instance, with this invention, not only can a user with a real-time review a custom, user specific generated presentation or report of items that they desire or need, but this disclosure provides a direct connection between digital information and a consumer's physical surroundings and can distinguish physical and empirical characteristics. For instance, these characteristics may include location in which to make a desired transaction, type or kind of merchant, prior frequency with which a consumer makes a transaction, amount of spending that consumer spends at a particular establishment as related to user interest or need. As such, the apparatus allows a customer (consumer, user, recommender, retailer, wholesaler, merchants) to improve intuitive distinguishing signals of future transactional information and may lead to more informed purchases and transactions and appealing and relevant retailer advertisements or displays.

In addition, the method and systems advantageously provides the ability to compile, download, store or review database information from different sources and adjust one or more indicators and details of a locality of goods and services into a more user friendly and understandable format, and into a real-time created customer user specific generated presentation or report.

Advantageously, in one embodiment, database model improves the detection by consumer of beneficial transactions when purchasing from merchants that are of a different type or kind thereof within one or more localities or locations. For example, custom user presentation based on locality of goods or services will provide a consumer while walking in one or more areas an informational presentation, for example, based on a multitude of products of services based on prior consumer purchases or a stored or generated consumer profile stored on a mobile communication device anywhere from expensive luxury goods or services, e.g., sports car, silks, antiques, collectables, cruise ship passages, collectables, or the like. Advantageously, in one embodiment, the system improves a user's ability to distinguish details of contemplated transactions and other finer features, e.g., custom user presentations based on user profile, user locality, and user actions, that could not otherwise using conventional electronic search engines software or apparatus. Furthermore, one or more routines of one embodiment unobtrusively provides objective evidence of beneficial transactions or information for promoters, recommenders, and retailers to utilize in evaluating future transactions or purchases to achieve a higher probability of satisfied consumer transactions. In addition, the principles of these embodiments can be part of a consumer transaction assistance program or service tool that will aid in the detection of beneficial transactions.

### Exemplary Apparatus, System, and Method

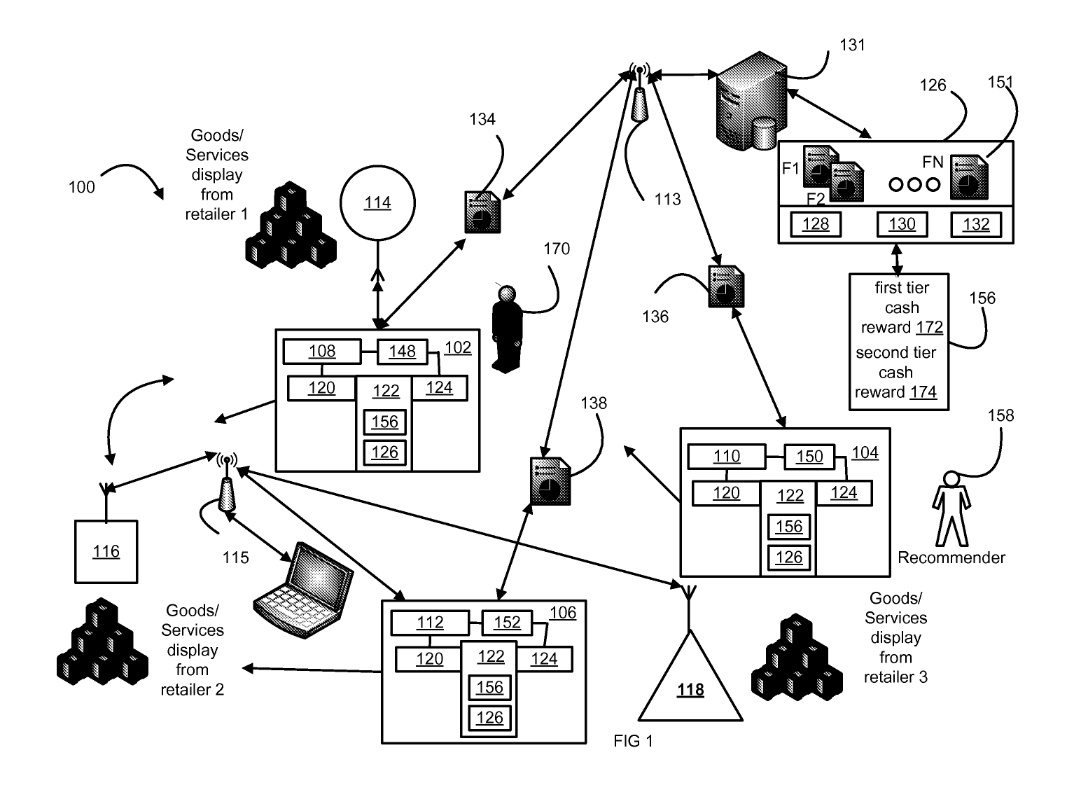

Referring to FIGS. 1-3, exemplary embodiments of the apparatus, system, and methods of the invention are described in detail. It will be appreciated that while described primarily in the context of a consumer-based purchase and referral rewards loyalty system, there are other uses, there are at least portions of the apparatus and other methodology for configuring the apparatus, system, and methodology described herein that may be used for other applications or purposes. For example, system and apparatus detects and displays on a mobile device a locality of purchasable items within an area or room from many different merchants and displays information to a consumer including goods or services price reductions or “special buys”, consumer purchase history, possible transactions and types, frequency of consumer transactions, and timing of prior consumer transactions.

In yet another example, the present disclosure may be used to create a consumer transaction system, transaction assist system, or provide assistance in the creation of consumer transaction models and empirical transaction charts that indicate objective information of transaction history and rationale to predict probability or desire for additional purchases or transactions. Other functionality or applications of the present disclosure may include providing objective evidence, rationale, and/or assistance in processing of retail and commercial transactions, determination of type goods or services to display or provide to a prospective consumer, monitoring of present consumer transactions, consumer loan application processing and clearance processing, and the like. As such, a myriad other functions will be recognized by those of ordinary skill given the present disclosure.

As used herein, the term “wireless” refers to wireless communication to a device or between multiple devices. Wireless devices may be anchored to a location and/or hardwired to a power system, depending on the needs of the business, venue, event or museum. In one embodiment, wireless devices may be enabled to connect to Internet, but do not need to transfer data to and from Internet in order to communicate within a wireless information communication and delivery system.

As used herein, the term “Smart Phone” or “smart phone” or “mobile communication device(s)” refers to a wireless communication device, that includes, but not is limited to, a transceiver, receiver, or transmitter, dynamic, static or non-transitory memory device(s), one or more computer processor(s) to process received and transmitted signals, for example, to and from the Internet, other wireless devices, and to provide communication within the wireless information communication and delivery system including send, broadcast, and receive information, signal data, location data, RSSI (Relative Signal Strength Indicator), one or more indications of signal strength to data tags from one or more information repositories, a bus line, an antenna to transmit and receive signals, and power supply such as a rechargeable battery or power storage unit.

In addition and as used herein, the term “Smart Phone” or “smart phone” or “mobile communication device(s)” refers to a wireless communication device, that includes, but not is limited to, an integrated circuit (IC), chip set, chip, system-on-a-chip including low noise amplifier, power amplifier, Application Specific Integrated Circuit (ASIC), digital integrated circuits, a transceiver, receiver, or transmitter, dynamic, static or non-transitory memory device(s), one or more computer processor(s) to process received and transmitted signals, for example, to and from the Internet, other wireless devices, and to provide communication within the wireless information communication and delivery system including send, broadcast, and receive information, signal data, location data, RSSI (Relative Signal Strength Indicator), one or more indications of signal strength to data tags from one or more information repositories, a bus line, an antenna to transmit and receive signals, and power supply such as a rechargeable battery or power storage unit. The chip or IC may be constructed (“fabricated”) on a “die” cut from, for example, a Silicon, Sapphire, Indium Phosphide, or Gallium Arsenide wafer. The IC may be, for example, analogue or digital on a chip or hybrid combination thereof. Furthermore, digital integrated circuits may contain anything from one to thousands or millions of signal invertors, and logic gates, e.g., “and”, “or”, “nand” and “nor gates”, flipflops, multiplexors, etc., on a square area that occupies only a few millimeters. The small size of, for instance, IC's allows these circuits to provide high speed operation, low power dissipation, and reduced manufacturing cost compared with more complicated board-level integration.

As used herein, the terms “location information” refer without limitation to any set or partial set of integer, real and/or complex location data or information such as longitudinal, latitudinal, and elevational positional coordinates or relative location coordinates to one or more objects, Wi-Fi networks, and wireless communication devices.

As used herein, the terms “wireless data transfer,” “wireless tracking and location system,” “positioning system” and “wireless positioning system” refer without limitation to any wireless system that transfers data or communicates or broadcasts a message, which communication may include location coordinates or advertisements using one or more devices, e.g., wireless communication devices.

As used herein, the terms “module” or “modules” refer without limitation to any software, firmware, or actual hardware or combination thereof that has been added on, downloaded, updated, transferred or originally part of a larger computation or transceiver system that assists in or provides computational ability including, but not limited to, logic functionality to assist in or provide communication broadcasts of commands or messages, which communication may include location coordinates or advertisements between, among, or to one or more devices, e.g., wireless communication devices.

Referring to FIG. 1, a consumer-based purchase and referral rewards loyalty system 100 is disclosed. In system 100 (e.g., wireless information and communication and delivery system 100), one or more mobile communication devices 102, 104, 106 communicatively couple to location tracking device, e.g., global positioning chip or circuit, audio tracking circuit, combination or the like 108, 110, 112. One or more wireless communication devices 114, 116, 118, e.g., data tags, audio devices, and/or Wi-Fi devices 113, 115, e.g., Wi-Fi enabled device, Wi-Fi device, Wi-Fi router, Wi-Fi transceiver, or the like couple or connect to data processing unit 120. In one variant, data tags 114, 116, 118 collect, store, and/or communicate an identification code of mobile communication devices 102, 104, 106, for instance, Wi-Fi devices 113, 115 to computer system 131. The identification code, for example, may be collected via methods discussed in incorporated priority applications, for instance, by monitoring RSSI of one or more mobile communication devices 102, 104, 106. Data processing unit 120 is enabled to communicate with memory unit 122 and data processing unit 124 of one or more location tracking devices 108, 110, 112 and one or more mobile communication devices 102, 104, 106. Custom sales presentation module 126, for instance firmware or software including functional capabilities, multiple presentation templates 128, tools 130 to manipulate, add, or change displayed elements 132. In one instance, custom sales presentation module communicatively couples, e.g., wirelessly, to one or more mobile communication devices 102, 104, 106 responsive to location information calculated, for instance, based on RSSI (Relative Signal Strength Indicator). For example, one or more location tracking devices 108, 110, 112 of mobile communication devices 102, 104, 106 calculate location information in accordance with methods disclosed in incorporated priority applications.

In one variant, the custom sales presentation module 126 is stored locally in memory, e.g., memory 122, in one or more mobile communication devices 102, 104, 106. In another variant, the custom sales presentation 126 may be accessible wirelessly by one or more of mobile communication devices 102, 104, 106 based on, for instance, location information including area or locality and/or based on assignment, for instance, in “real-time” by one or more advertiser or merchant based on, for instance, area or demographics and/or in combination with one or more specified criteria. In another variant, custom sales presentation module 126 couples to one or more mobile communication devices 102, 104, 106. In another alternative, Wi-Fi device(s) or data tag(s) 113, 114, 115, 116, 118 couple to computer 131 to generate user specific sales presentation 134, 136, 138 using custom sales presentation module 126. User specific sales presentation 134, 136, 138 is responsive to a locality of goods or services proximal to or predicted to be proximal to a location of at least one of one or more mobile communication devices 102, 104, 106. For instance, mobile communication device 102 has custom sale presentation 134 created and responsive to locality of goods/services from retailer 1 proximal to wireless communication device 114 and heading to goods/services from retailer 2. In another example, mobile communication device 104 has custom sale presentation 136 created and responsive to locality of goods/services from retailer 3 proximal to wireless communication device 118 and heading to goods/services from retailer 1. In yet another example, mobile communication device 106 has custom sales presentation 138 created and responsive to locality of goods/services from retailer 3 proximal to wireless communication device 118 and heading to goods/services from retailer 2. Locality of goods/services and distance to or from mobile communication devices 102, 104, 106 may be determined, for instance, using location tracking based on location information, e.g., RSSI (Relative Signal Strength Indicator) collected by one or more wireless communication devices 114, 116, 118 (e.g., data tags 114, 116, 118) as discussed previously in claimed priority applications.

In one variant, user specific sales presentation 134, 136, 138 includes a visual and graphical format responsive to user profile including likes and dislikes on user specific profile 148, 150, 152 of at least one of one or more mobile communication devices 102, 104, 106. In yet another variant, user specific sales presentation 134, 136, 138 includes from custom sales presentation module 126 a random selection of presentation formats 151 (e.g., formats F1, F2 . . . Fn). In one alternative, presentation formats 151 may include visual and graphical format presentation sections arranged responsive to likes and dislikes of user specific profile 148, 150, 152 loaded, stored, or collected on one or more mobile communication devices 102, 104, 106. In yet another example, user specific presentation 134, 136, 138 includes visual and graphical format response to user's behavioral responses to one or more advertisement specific notifications. Consumer credit module 156, e.g., software or firmware, that collects, stores, and communicates to user 170 or recommender 158 that receives tiered cash reward 160, e.g., a specified payout or payment, into consumer credit module 156, e.g., stored in memory, e.g., memory 122, either locally or remotely for user or recommender's mobile communication device, responsive to one or more specified criteria.

In one variant, one or more specified criteria includes if an advertisement for targeted goods or services as identified by an advertiser, for instance, is provided as part of custom user presentation. For example, customer user presentation 134 is communicated to user 170 of mobile communication device 102, who views presentation 134 after communication, e.g., SMS message, Internet posting, by recommender 158 of mobile communication device 104 (e.g., user who recommends goods or services to another user), and recommender 158 receives, for instance, first tier cash reward 172. In one variant, if user 170 of mobile communication device 102 purchases after viewing custom user presentation 134, and recommender 158 of mobile communication device 104 may receive second tier cash reward 174.

In yet another instance, one or more specified criteria may include actions performed by user or recommender (e.g., one who informs user to consider a specified set of goods or services) may include, for instance, any or all the following: sharing advertisements by posting on electronic bulletin board or web page on a social media network, recommending using short message service (SMS) or text messaging service, redemption of one or more earned credits by a user or recommender for targeted goods or services including any venues that accept credit card payments. Still other actions performed by a user or recommender may include RSVP (please respond) including signing-up or reserving a spot to attend a social media event, registration including reservations to attend a number or specific social media event by user(s) or recommender(s).

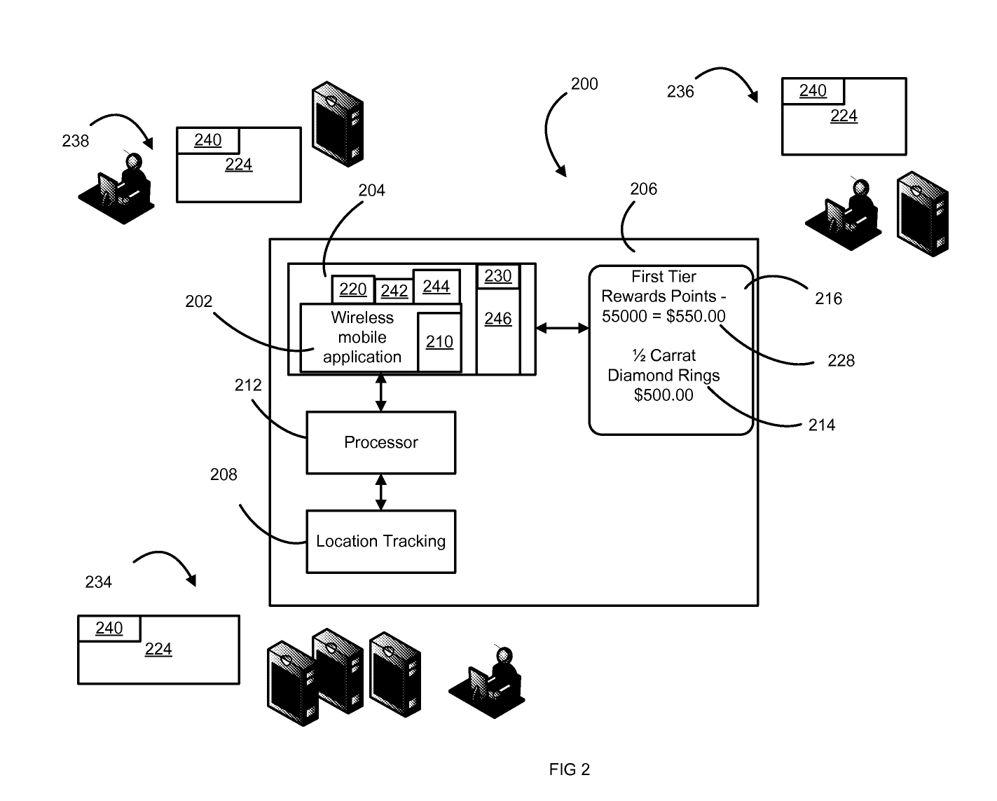

Referring to FIG. 2, system 200 (e.g., wireless information communication and delivery system 200) includes wireless mobile application 202, e.g., firmware or software, stored in non-volatile memory 204 of mobile communication device 206, e.g., mobile cell phone, and communicatively coupled to an internal processor 212 on mobile communication device 206. Wireless mobile application 202 includes rewards software program 210, e.g., firmware or software, to record, store, and communicate, executable on internal mobile phone processor 212 such as custom sales presentation module 126. In one instance, wireless mobile application 202 is configured to display user statics 214 on user interface 216 and generate monetary rewards or offers responsive to any or all the following: wireless mobile phone usage 220, based on recorded time 242 of user or recommender mobile cell phone 206, and/or proximal location to groupings of one or more tagged devices 224 (e.g., including data tags) or actions performed by user, e.g., user 170, or recommender, e.g., recommender 158 who is also a user, and or actions performed by advertiser or marketer, e.g., also a user of the customer sales presentation module 126.

For instance, proximal location to groupings of one or more tagged devices 224 including location information may be determined using one or more location tracking methodologies, e.g., identification code being collected by wireless communication devices (data tags) responsive to RSSI receiving, recording, communicating, and tracking, and methods for tracking and identifying mobile communication devices illustrated in incorporated by reference in entirety priority patent applications. For instance, location tracking module 208 communicates location information using RSSI, such as by methods or apparatus disclosed in incorporated by reference priority patent applications, that is located, stored, and/or collected by wireless communication device(s) (data tag(s) 224) illustrated in FIG. 2 and located at locations 234, 236, and 238. In another variant, actions performed by user or recommender (e.g., one who informs someone to consider a specified set of goods or services) may include, for instance, any or all the following: sharing advertisements by posting on electronic bulletin board or web page on a social media network. Still other actions may include recommending using short message service (SMS) or text messaging service. Yet other actions may include redemption of one or more earned credits by user or recommender for goods or services including one or more venues (electronic stores, physical stores, and the like) accepting credit card payments. Still other actions performed by user or recommender may include RSVP (please respond) requests including whether or not user and/or recommender plans to attend a social media event, registration including reservations to attend a number or specific social media event by one or more users or recommenders.

In one variant, system 200 is configured to display user statics 214 includes display of users deposited cash 228 responsive to user rewards 230 in user account 246 that are available to redeem toward future purchases at selected retailers. In one variant, rewards software program 210 based on recorded time 242 of mobile communication device 206 proximal location to groupings to one or more tagged devices 224 includes accumulation of time of mobile communication device 206 proximal to a particular type or variety of consumer good items 234 in area 236. In one instance, area 236 includes at least one of a convenience store, department store, discount store, and a theme store. In one example, grouping of one or more tagged devices 224 includes a series of mobile transceiver or receiver devices 240 positioned throughout consumer retail shopping area 234, 236, 238, categorically recorded, and updated to maintain a running inventory of consumer purchasable items in one or more areas of consumer retail shopping area 234, 236, 238.

In one variant, upon approval of user, consumer retailer provides “special discounts” and “special monetary offers” in user account 246 based on at least one of user statics 214, one or more special occasions or special occasions user preferences lists 244, and a period recorded proximal to one or more consumer retail displays 234, 236, 238 in consumer retailer's store. In another example, one or more special occasions or special occasions user preference lists 224 includes user desired purchases in one or more selected categories in accordance with a special occasion and accessible by limited number of other users. In one alternative, recorded time 242 includes an accumulation of time of mobile communication device 206 proximal to one or more retailer consumer product displays categorized in accordance with type of store. In yet another instance, recorded time includes an accumulation of time of cross section or demographics of user profiles on one or more selected wireless communication devices proximal to one or more retailers' consumer product displays. In one variant, one or more retailer consumer product displays are categorized in accordance with retailers' preferences within a type of store and location of store from home address of cross section or demographics of user profiles on one or more mobile communication devices, e.g., mobile communication device 206, proximal to the one or more retailer consumer product displays 234, 236, 238.

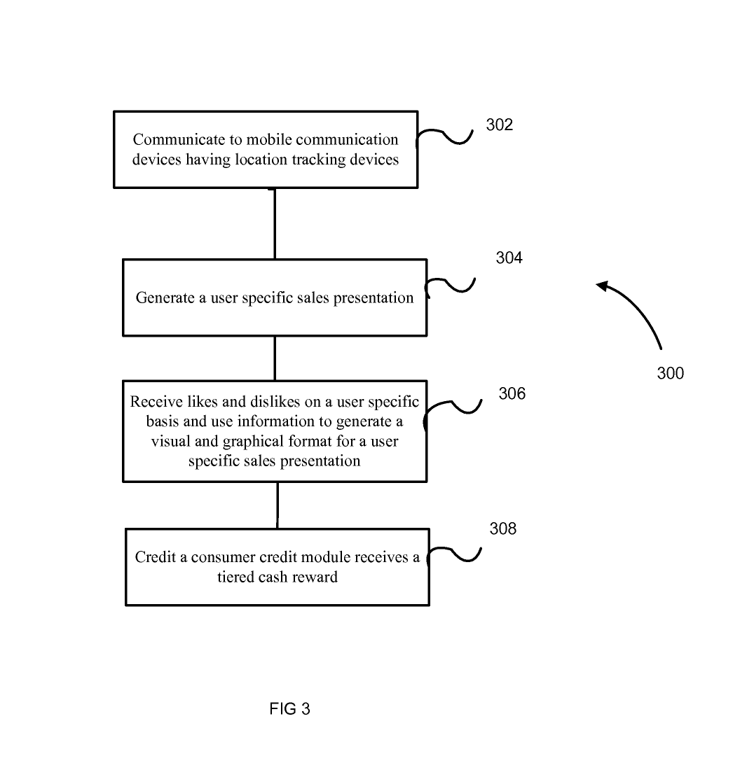

Referring to FIG. 3, a method 300 is disclosed for a consumer-based rewards loyalty program. In step 302, the method communicates by at least one processing unit from one or more data tags to one or more mobile communication devices having a location tracking device, at least one memory unit, and one or more processing units. In step 304, the method generates a user specific sales presentation from a custom sales presentation module, the user specific sales presentation being responsive to a locality of goods or services proximal to or predicted to be proximal to the one or more location tracking devices and the one or more data tags and/or actions by a user. In one variant of step 304, the method may include communicatively coupling the user specific sales presentation to the mobile communication devices. In yet another variant, the method may include providing a recommendation from a recommender to a user by at least one of a short message service (SMS) or an Internet webpage or social media webpage posting, e.g., Facebook, Twitter, or the like, that is shared with others on or among one or more social media networks to view advertised goods or services.

In step 306, the method may include receiving by the custom presentation module a stored profile including likes and dislikes on a user specific basis of at least one of the one or more mobile communication devices and using this information to generate a visual and graphical format for the user specific sales presentation. In one variant of step 306, the method may include randomly selecting from the custom sales presentation module from a library of presentation forms including the visual and graphical format presentation sections arranged responsive to likes and dislikes of a user profile loaded on the mobile communication device. In another variant of step 306, the method includes formatting within the user specific presentation a visual and graphical format response to a user's behavioral responses from a database in accordance with one or more advertisement specific notifications.

In step 308, the method includes crediting a consumer credit module of a recommender receives a tiered cash reward responsive to one or more specified criteria. In one variant, the one or more specified criteria includes recommendation of advertisement for targeted goods or services as part of a custom communicated to user who views the recommendation, the recommender receives a first tier cash reward and if the user purchases after viewing the advertisement, recommender receivers a second tier cash reward. In another variant, the one or more specified criteria includes at least one of viewed advertisements by user based on a recommendation by recommender and “clicked-thru” from one website to other websites by a user based on recommendation by recommender including ecommerce websites. In yet another variant, the one or more specified criteria based on one or more requested actions obtained from an advertisers display including at least one of redemption, RSVP, and registration. In yet another instance, one or more specified criteria may further include a flexible reward tier system adjustable in accordance with at least one of venue, advertiser, retailer, and a company.

In one alternative, one or more specified criteria may include usage of custom sales presentation module whereby rewards are measured on usage basis and rewards are tiered in accordance with categorical ranges that related to payout amounts to user of custom sales presentation module. Categorical ranges may be related ranges of usage of time spent using the custom sales presentation module. For example, for usage and recommendations between 0 and 15 minutes, user or recommender receives $0.10, for usage and recommendations between 16 to 30 minutes, user or recommender receives $0.40 per recommendation, for usage and recommendations between 31 and greater minutes, user or recommender receives $0.50. In one alternative, the usage using the custom sales presentation may be measured on a daily or a 24-hour usage basis.

Advantageously, the disclosure analyzes consumer transactions to produce a user custom sale presentation that detects objective information. The consumer transaction may be illustrated, for instance, in a stored or predicted consumer profile on a mobile communication device based on analysis of elements of consumer data sets. In one variant, elemental categories may include types and kinds of goods or services that a consumer has performed in the past. In yet another variant, consumer transactions and types of spending may be analyzed based on results of one or more purchases of items such as boats, recreation vehicles, movie tickets, vacation rentals, and the like.

In yet another variant, consumer spending patterns that may include variables of locality or location of charging, time of charging, frequency, number of and variety of distinct areas or state of charging within a period of time, and the like. As such, information relative to transactions and advertisements are monitored through a series of firmware routines and processed. Thus, this system sorts and groups advertisement and user transactions and stores their respective dependencies.

Advantageously, the embodiments of the present disclosure may be utilized as assistance or assistive tool for the consumer or retailers. In other instance, principles of the present invention may, in many cases, provide a tool for generating objective evidence to assist in the collection of transaction information on consumers.

While the above detailed description has shown, described, and pointed out as novel features of the invention as applied to various embodiments, it will be understood that various omissions, substitutions, and changes in the form and details of the device or process illustrated may be made by those skilled in the art without departing from the invention. The foregoing description includes a best mode presently contemplated of carrying out the invention. This description is in no way meant to be limiting, but rather should be taken as illustrative of the general principles of the invention.

We claim:

1. A consumer-based purchase and referral rewards loyalty system, the system comprising:
one or more location tracking devices communicatively coupled to one or more mobile communication devices;
one or more data tags having at least one data processing unit enabled to communicate with at least one memory unit of the one or more mobile communication devices to collect an identification code of each; and
a custom sales presentation module communicatively coupled to the one or more location tracking devices and the one or more data tags, the custom sales presentation module generates a user specific sales presentation responsive to a locality of goods or services proximal to or predicted to be proximal to a location of at least one of the one or more location tracking devices.

2. The system of claim 1, wherein the user specific sales presentation includes a visual and graphical format responsive to a user profile including likes and dislikes on a user specific profile or user specific basis of at least one of the one or more location tracking devices.

3. The system of claim 1, wherein the user specific sales presentation includes from the custom sales presentation module a random selection of presentation formats with visual and graphical format presentation sections arranged responsive to likes and dislikes of a user specific profile loaded, stored, or collected on the one or more mobile communication devices.

4. The system of claim 1, wherein the user specific presentation includes a visual and graphical format response to a user's behavioral responses to one or more advertisement specific notifications.

5. The system of claim 1, a consumer credit module when a recommender receives a tiered cash reward responsive to one or more specified criteria.

6. The system of claim 5, wherein the one or more specified criteria includes: a recommendation of an advertisement for a targeted goods or services as part of the custom sales presentation module communicated to a user and who views the recommendation, the recommender receives a first tier cash reward and if the user purchases after viewing the advertisement, the recommender receivers a second tier cash reward.

7. A system including a wireless mobile application stored in non-volatile memory of one or more mobile communication devices and communicatively coupled to one or more location tracking devices, the system comprising:
a rewards software program of the wireless mobile application to record, store, and communicate, executable on an internal mobile phone processor; wherein the system is configured to display a user statics on a user interface and to generate monetary rewards or offers responsive to a wireless mobile phone usage and based on at least one of a recorded time of a mobile cell phone proximal location to groupings of one or more tagged devices and actions performed by a user specified by or within the rewards software program.

8. The system of claim 7, wherein the system is configured to display the user statics includes display of users deposited cash responsive to a user rewards in a user account that are available to redeem toward future purchases at selected retailers or any venue that accepts credit card.

9. The system of claim 7, wherein based on the recorded time of a mobile cell phone proximal location to groupings to one or more tagged devices includes accumulation of time of a mobile cell phone proximal to a particular type or variety of consumer good items in an area.

10. The system of claim 9, wherein the area includes at least one of a convenience store, department store, discount store, and a theme store.

11. The system of claim 7, wherein grouping of one or more tagged devices includes a series of mobile transceiver or receiver devices positioned throughout a consumer retail shopping area and categorically recorded and updated to maintain a running inventory of consumer purchasable items in one or more areas of the consumer retail shopping area.

12. The system of claim 7, wherein upon approval of a user, a consumer retailer provides special discounts and special monetary offers in a user account based on at least one of the user statics, one or more special occasions user preferences lists, and a period of a user recorded proximal to one or more consumer retail displays in a consumer retailer's store.

13. The system of claim 12, wherein the one or more special occasions user preferences lists includes user desired purchases in one or more selected categories in accordance with a special occasion and accessible by a limited number of other users.

14. The system of claim 7, wherein the recorded time includes an accumulation of time of a wireless communication device proximal to one or more retailers' consumer product displays categorized in accordance with type of store or in accordance with actions performed by the user of the wireless mobile application including sharing, recommending, redemption, RSVP, and registration on an ecommerce website.

15. The system of claim 7, wherein the recorded time includes an accumulation of time of a cross section of one or more selected wireless communication devices proximal to one or more retailer consumer product displays categorized in accordance with retailers' preferences within a type of store and location of store from a home address of the cross section of the one or more wireless communication devices proximal to the one or more retailer consumer product displays.

16. A method for operating a consumer-based rewards loyalty program, the method comprising:
communicating by at least one processing unit from one or more data tags or Wi-Fi routers to one or more mobile communication devices having a location tracking device, at least one memory unit, and one or more processing units; and
generating a user specific sales presentation from a custom sales presentation module, the user specific sales presentation being responsive to a locality of goods or services proximal to or predicted to be proximal to the one or more location tracking devices and the one or more data tags; and
communicatively coupling the user specific sales presentation to the mobile communication devices.

17. The method of claim 16, further comprising receiving by the custom presentation module a stored profile including likes and dislikes on a user specific basis of at least one of the one or more location tracking devices and using this information to generate a visual and graphical format for the user specific sales presentation.

18. The method of claim 16, further comprising randomly selecting from the custom sales presentation module from a library of presentation forms including visual and graphical format presentation sections arranged responsive to likes and dislikes of a user profile loaded on the mobile communication device.

19. The method of claim 16, further comprising formatting within the user specific sales presentation includes a visual and graphical format response to a user's behavioral responses from a database in accordance with one or more advertisement specific notifications.

20. The method of claim 16, further comprising crediting a consumer credit module of a recommender receives a tiered cash reward responsive to one or more specified criteria.

21. The method of claim 20, wherein the one or more specified criteria includes a recommendation of an advertisement for a targeted good or service as part of the user specific sales presentation communicated to a user by a recommender and the user views the recommendation, the recommender receives a first tier cash reward and if the user purchases after viewing the advertisement, the recommender receivers a second tier cash reward.

22. The method of claim 20, wherein the one or more specified criteria includes at least one of viewed advertisements by a user based on a recommendation by a recommender and “clicked thru” from one website to other websites by a user based on a recommendation by a recommender including ecommerce websites.

23. The method of claim 16, further comprising providing a recommendation from a recommender to a user by at least one of a short message service (SMS) or an Internet webpage or social media webpage posting that is shared with others on a social media network to view advertised goods or services.

24. The method of claim 22, wherein the one or more specified criteria based on one or more requested actions obtained from an advertisers display including at least one of redemption, RSVP, and registration; and wherein the one or more specified criteria include a flexible reward tier system adjustable in accordance with at least one of venue, advertiser, retailer, and a company.

25. The method of claim 22, wherein the one or more specified criteria include usage of the custom sales presentation module whereby rewards are measured on a usage basis and the rewards are tiered in accordance with categorical ranges that related to payout amounts to a user of the custom sales presentation module.
